(19) United States
(12) Patent Application Publication
(10) Pub. No.: US 2012/0161510 A1
(43) Pub. Date: Jun. 28, 2012

(54) SEAL ASSEMBLY

(75) Inventors: Mark S. DIEKEVERS, Metamora, IL (US); Beth A. SEBRIGHT, Chillicothe, IL (US); Guanghui LIANG, Dunlap, IL (US)

(73) Assignee: Caterpillar Inc., Peoria, IL (US)

(21) Appl. No.: 13/313,158

(22) Filed: Dec. 7, 2011

Related U.S. Application Data
(60) Provisional application No. 61/426,565, filed on Dec. 23, 2010.

(51) Int. Cl. F16J 15/32; B32B 37/12; B32B 38/00; F16J 15/16; B62D 55/088

(52) U.S. Cl. 305/104; 277/500; 277/549; 156/281; 156/153

(57) ABSTRACT

A seal assembly includes a first member that pivots about an axis of a joint relative to a second member. The seal assembly includes adhesive, a seal ring and a load ring for a seal cavity of the first member. The adhesive may be applied between at least one of the seal cavity and a first end face, the seal cavity and a first surface, the seal ring and an annular inner peripheral surface, the seal ring and a second surface, and the seal ring and a second end face. Alternatively, the seal cavity may comprise a roughened area where the load ring contacts the seal cavity.

### RELATED APPLICATIONS

This application is based upon, claims priority to, and otherwise claims the benefit of U.S. Provisional Application No. 61/426,565 by Mark S. Diekevers, et al., filed Dec. 23, 2010, the contents of which are expressly incorporated herein by reference.

### TECHNICAL FIELD

The present disclosure relates to seals. More particularly, the present disclosure relates to a seal assembly and method for assembling a seal assembly. Such a seal assembly may be used for sealing a track joint in a track chain.

### BACKGROUND

In recent years, attention has been given to sealing joints in moving vehicles, and more particularly to an apparatus for sealing a track joint in a track chain. For example, crawler tractors, such as a bulldozer, typically have a sprocket, an idler, a track chain and a number of track shoes attached to the track chain for propelling the tractor over the ground. During use of the crawler tractor the sprocket rotates and engages the track chain, thereby causing the track chain, along with the attached track shoes, to rotate around a path defined by the sprocket and the idler. The rotation of the track chain causes the track shoes to engage the ground, thereby propelling the crawler tractor over the ground to perform various work functions.

Track chains generally include a pair of parallel chains, with each parallel chain being made up of a series of entrained master links and track links. Some track chains may further include a series of pins and bushings interposed between and connected to the parallel chains. The bushings and the entrained track links cooperate to form a number of track joints which allow the necessary movement of the bushings relative to the track links during use of the track chain, for example when the track chain rotates about the sprocket and the idler. Track joints are typically equipped with a track seal assembly to keep out various corrosive and abrasive mixtures of water, dirt, sand, rock or other mineral or chemical elements to which the track chain is exposed during its use. The track seal assembly also functions to keep a lubricant within the track joint to facilitate the aforementioned relative movement of the bushings and the track links.

A problem with track seal assemblies is to keep dirt out and keep lubrication within the track joint. Another problem to consider is to maintain sealing capability. It is desired to maintain the different parts of a track seal assembly in place to avoid displacement of any parts and resulting loss of sealing capability. The stability of a load ring within a seal assembly may be a problem. Stability of a load ring may be effected by dirt pushing on the load ring.

Other problems to consider alone or in combination with other mentioned problems relate to grooving of the different parts of a seal assembly. Grooving may arise by various abrasive particles found in the working environment of a track chain finding its way in to a seal assembly. If such grooving arises, then not only dirt may enter a track joint, but also lubrication within the track joint may escape.

It is further desirable to keep costs for manufacturing and/or assembling a seal assembly within a track joint down. It may also be desirable to avoid cumbersome arrangements. It may also be desirable to provide a simple assembling process of a track joint seal assembly.

The present invention is directed to overcoming one or more of the problems as set forth above.

### SUMMARY OF THE INVENTION

In one aspect, the present disclosure is directed to a seal assembly for sealing between a first member and a second member of a joint, the first member being able to pivot about an axis of the joint relative to the second member. The seal assembly includes a seal ring for a seal cavity of the first member, a load ring for the seal cavity of the first member, and an adhesive. The load ring includes an annular outer peripheral surface for engaging the seal cavity, an annular inner peripheral surface for engaging the seal ring, a first end face for engaging the seal cavity, a second end face for at least partly engaging the seal ring, a first surface for engaging the seal cavity, the first surface connecting the first end face and the annular outer peripheral surface, and a second surface for engaging the seal ring, the second surface connecting the annular inner peripheral surface and the second end face. The adhesive may be between at least one of the seal cavity and the first end face, the seal cavity and the first surface, the seal ring and the annular inner peripheral surface, the seal ring and the second surface, and the seal ring and the second end face.

In one aspect, the present disclosure is directed to a method for assembling a seal assembly for sealing between a first member and a second member of a joint, the first member being able to pivot about an axis of the joint relative to the second member. The seal assembly includes a seal ring for a seal cavity of the first member, and a load ring for the seal cavity of the first member. The method comprising the following steps:

a) cleaning the seal ring and the load ring,

b) applying adhesive to at least one of the seal ring and the load ring,

c) assembling the load ring to the seal ring,

d) cleaning the seal cavity and the load ring,

e) applying adhesive to at least one of the seal cavity and the load ring,

f) assembling the load ring and the seal ring into the seal cavity into its final service position, and

g) allowing time for the adhesive to cure while the load ring and the seal ring are in the final service position.

In another aspect, the present disclosure is directed to a seal assembly for sealing between a first member and a second member of a joint, the first member being able to pivot about an axis of the joint relative to the second member. The seal assembly including a seal ring for a seal cavity of the first member, a load ring for the seal cavity of the first member, and an adhesive. The load ring having an annular outer peripheral surface for engaging the seal cavity, an annular inner peripheral surface for engaging the seal ring, a first end face for engaging the seal cavity, a second end face for at least partly engaging the seal ring, a first surface for engaging the seal cavity, the first surface connecting the first end face and the annular outer peripheral surface, and a second surface for engaging the seal ring, the second surface connecting the annular inner peripheral surface and the second end face. The seal cavity comprises a roughen area where the load ring contacts the seal cavity. The adhesive may be between at least one of the seal ring and the annular inner peripheral surface, the seal ring and the second surface, and the seal ring and the second end face.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment(s).

### BRIEF DESCRIPTION OF THE DRAWINGS

The accompanying drawings illustrate presently preferred exemplary embodiments of the disclosure, and together with the general description given above and the detailed description of the preferred embodiments given below, serve to explain, by way of example, the principles of the disclosure.

FIG. 1 is a diagrammatic illustration of a seal assembly according to an exemplary embodiment of the present disclosure;

FIG. 2 is a diagrammatic illustration of a part of a load ring according to an exemplary embodiment of the present disclosure;

FIG. 3 shows a cross section of the load ring of FIG. 2;

FIG. 4 is a diagrammatic illustration of a part of a load ring according to an exemplary embodiment of the present disclosure; and

FIG. 5 shows a cross section of the load ring of FIG. 4.

### DETAILED DESCRIPTION

At least one embodiment concerns seal assemblies for track joints. Seal efficiency of such seal assemblies may be improved by improving the stability of a load ring within the seal assembly. The stability of the load ring may be increased by adhesive and/or friction. By providing adhesive and/or increased friction at certain areas between the load ring and a seal cavity and between the load ring and a seal ring, the stability of the load ring can be increased. This may result in an improved seal assembly. In at least one embodiment, the combination of areas with increased friction and areas with adhesive is used to stabilize a load ring of a seal assembly.

At least one embodiment discloses a method for assembling such a seal assembly. When assembling the seal assembly, care should be taken that the parts of the seal assembly are assembled correctly. This may be provided for by allowing the adhesive to cure first when the parts of the seal assembly are in their final service positions. This may result in the stability of the load ring to increase. This may result in an improved seal assembly.

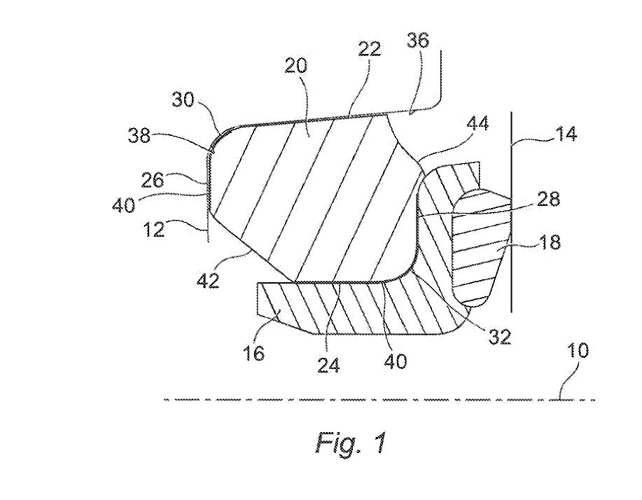

Turning to FIG. 1, an exemplary embodiment discloses a seal assembly for sealing between a first member 12 and a second member 14 of a joint, the first member 12 being able to pivot about an axis 10 of the joint relative to the second member 14. The first member 12 and the second member 14 may be parts of two links of a track joint.

The seal assembly may include a seal ring 16, a load ring 20, and an adhesive 40. The seal ring 16 may be located in a seal cavity 36 of the first member 12. The load ring 20 may be located in the seal cavity 36 of the first member 12. This would be their final service positions within the seal assembly.

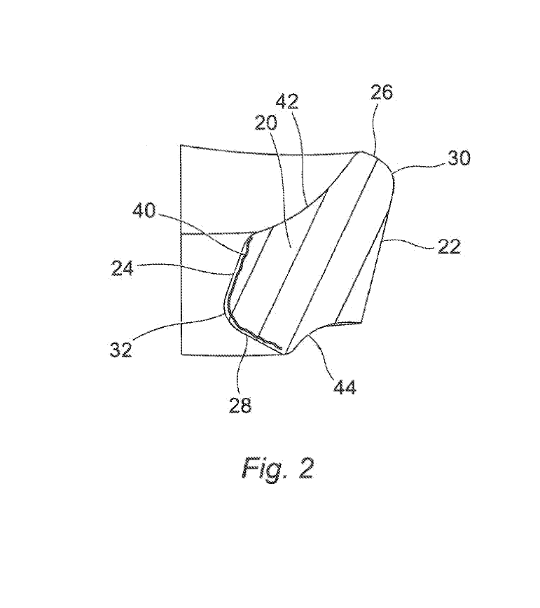

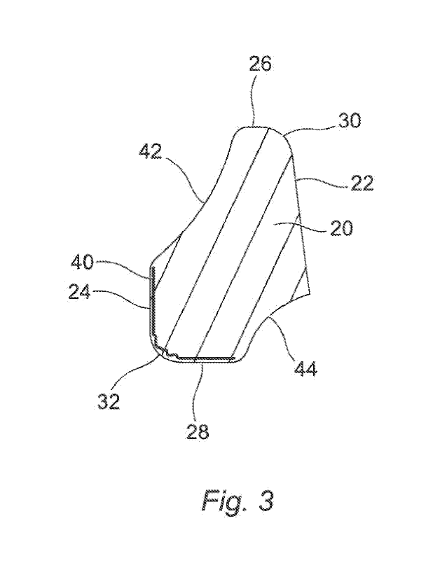

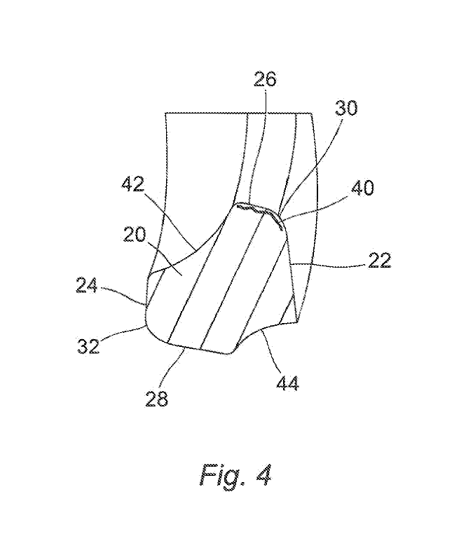

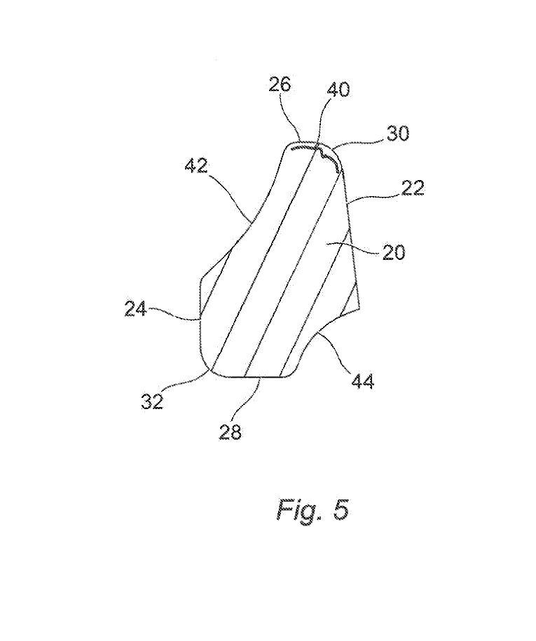

Exemplary embodiments of the load ring 20 are illustrated in FIG. 1 to FIG. 5. In FIG. 2 to FIG. 5 the load ring 20 is in an uncompressed state. In FIG. 1 the load ring 20 is engages the seal cavity 36 and the urges the seal ring 16 to seal against the second member 14. In one embodiment, the seal ring 16 comprises plastic and a seal lip 18.

In at least one embodiment, the load ring 20 comprises an annular outer peripheral surface 22 for engaging the seal cavity 36, an annular inner peripheral surface 24 for engaging the seal ring 16, a first end face 26 for engaging the seal cavity 36, and a second end face 28 for at least partly engaging the seal ring 16. The load ring 20 further comprises a first surface 30 for engaging the seal cavity 36, the first surface 30 connecting the first end face 26 and the annular outer peripheral surface 22. The load ring 20 further comprises a second surface 32 for engaging the seal ring 16, the second surface 32 connecting the annular inner peripheral surface 24 and the second end face 28. The shapes and forms of these surfaces and faces may vary to provide a load ring 20 with suitable properties.

In one embodiment, the load ring 20 may further comprise a first waist surface 42 connecting the first end face 26 and the annular inner peripheral surface 24. The load ring 20 may further comprise a second waist surface 44 connecting the second end face 28 and the annular outer peripheral surface 22. The shapes and forms of these surfaces may vary to provide a load ring 20 with suitable properties.

According to one embodiment, an adhesive 40 may be used for improving stability and/or location of the load ring 20. The adhesive 40 may be applied to a surface of the load ring 20 or to a surface of the seal cavity 36, or both. The adhesive 40 may be applied to a surface of the load ring 20 or to a surface of the seal ring 16, or both. The adhesive 40 may be applied between the seal cavity 36 and the first surface 30. The adhesive 40 may be applied between the seal cavity 36 and the first end face 26. The adhesive 40 may be applied between the seal ring 16 and the annular inner peripheral surface 24. The adhesive 40 may be applied between the seal ring 16 and the second surface 32. The adhesive 40 may be applied between the seal ring 16 and the second end face 28. Any combination of these places for the adhesive may be used.

While the adhesive 40 may be applied between at least one of the seal cavity 36 and the first end face 26, the seal cavity 36 and the first surface 30, the seal ring 16 and the annular inner peripheral surface 24, the seal ring 16 and the second surface 32, and the seal ring 16 and the second end face 28, there are some preferred places. According to at least one embodiment, the most preferred place for the adhesive is between the seal cavity 36 and the first surface 30, hereafter between the seal cavity 36 and the first end face 26, hereafter between the seal ring 16 and the second end face 28, hereafter between the seal ring 16 and the second surface 32, and hereafter between the seal ring 16 and the annular inner peripheral surface 24.

According to one embodiment, the adhesive 40 is an adhesive 40 that cures after the joint has been assembled. According to one embodiment, the adhesive 40 is annularly applied around the seal cavity 36. According to one embodiment, the seal ring 16 is comprised of plastic and comprises a seal lip 18.

In at least one embodiment, the seal assembly is part of a track pin. A vehicle, such as for example a crawler tractor, may comprise the seal assembly.

One embodiment is a method for assembling a seal assembly. The seal assembly seals between a first member 12 and a second member 14 of a joint, the first member 12 being able to pivot about an axis 10 of the joint relative to the second member 14. The seal assembly comprises a seal ring 16 for a seal cavity 36 of the first member 12 and a load ring 20 for the seal cavity 36 of the first member 12. The seal assembly may be a disclosed embodiment of a seal assembly herein.

The method may comprise the following steps:

a) cleaning the seal ring 16 and the load ring 20,

b) applying adhesive 40 to at least one of the seal ring 16 and the load ring 20,

c) assembling the load ring 20 to the seal ring 16,

d) cleaning the seal cavity 36 and the load ring 20,

e) applying adhesive 40 to at least one of the seal cavity 36 and the load ring 20,

f) assembling the load ring 20 and the seal ring 16 into the seal cavity 36 into its final service position, and

g) allowing time for the adhesive 40 to cure while the load ring 20 and the seal ring 16 are in the final service position.

According to one embodiment, the load ring 20 may be assembled first to the seal cavity 36 and then the seal ring 20 may be assembled to the load ring 20. However, this may be a somewhat more cumbersome assembly.

According to one embodiment, the load ring comprises an annular outer peripheral surface 22 for engaging the seal cavity 36, an annular inner peripheral surface 24 for engaging the seal ring 16, a first end face 26 for engaging the seal cavity 36, a second end face 28 for at least partly engaging the seal ring 16, a first surface 30 for engaging the seal cavity 36, the first surface 30 connecting the first end face 26 and the annular outer peripheral surface 22, and a second surface 32 for engaging the seal ring 16, the second surface 32 connecting the annular inner peripheral surface 24 and the second end face 28. Step b) mentioned above may comprise applying the adhesive 40 between at least one of the seal ring 16 and the annular inner peripheral surface 24, the seal ring 16 and the second surface 32, and the seal ring 16 and the second end face 28. Any one position of these three or any combinations thereof may be used. According to at least one embodiment, the most preferred place for the adhesive 40 is between the seal ring 16 and the second end face 28, hereafter between the seal ring 16 and the second surface 32, and hereafter between the seal ring 16 and the annular inner peripheral surface 24. The adhesive 40 may be applied to one of the surfaces of the seal ring 16 and/or one of the surfaces of the load ring 20.

According to one embodiment, step e) mentioned above may include to apply the adhesive 40 between at least one of the seal cavity 36 and the first end face 26, and the seal cavity 36 and the first surface 30. Any one position of these two or any combinations thereof may be used. According to at least one embodiment, the most preferred place for the adhesive 40 is between the seal cavity 36 and the first surface 30, and hereafter between the seal cavity 36 and the first end face 26. The adhesive 40 may be applied to one of the surfaces of the seal cavity 36 and/or one of the surfaces of the load ring 20.

According to one embodiment, the cleaning is done by using chemicals. Any suitable chemical may be used, depending on the adhesive 40 to be applied.

The adhesive in step b) may be annularly applied to a corner of the seal cavity 36 where the load ring 20 would contact. The adhesive in step e) may be annularly applied to a corner of the seal ring 20 being L-shaped. The seal ring 20 may be L-shaped having one flange extending in a radial direction and one flange extending in an axial direction.

According to one embodiment, a surface may, as an alternative or addition to adhesive, be given a higher coefficient of friction, preferably above 0.2. Such a surface may stabilize the load ring 20 in the seal assembly. The steps d) and e) mentioned above may be omitted and the seal cavity 36 may comprise a roughen area 38 where the load ring 20 contacts the seal cavity 36. Such roughening may be made by, for example, blasting, knurling, or controlled turning.

According to one embodiment, a seal assembly may seal between a first member 12 and a second member 14 of a joint, the first member 12 being able to pivot about an axis 10 of the joint relative to the second member 14. The seal assembly comprises a seal ring 20 for a seal cavity 36 of the first member 12, a load ring 20 for the seal cavity 36 of the first member 12, a roughen area 38, and an adhesive 40.

The load ring 20 may have an annular outer peripheral surface 22 for engaging the seal cavity 36, an annular inner peripheral surface 24 for engaging the seal ring 20, a first end face 26 for engaging the seal cavity 36, and a second end face 28 for at least partly engaging the seal ring 20. The load ring 20 may comprise a first surface 30 for engaging the seal cavity 36 and the first surface 30 may connect the first end face 26 and the annular outer peripheral surface 22. The load ring 20 may comprise a second surface 32 for engaging the seal ring and the second surface 32 may connect the annular inner peripheral surface 24 and the second end face 28.

The seal cavity 36 comprises the roughen area 38 where the load ring 20 contacts the seal cavity 36. This roughen area 38 is located in a corner between a surface extending substantially in a radial direction of the seal cavity 36 and a surface extending substantially in an axial direction of the seal cavity 36. While the load ring 20 may contact other areas than the roughen area 38 of the seal cavity 36, the roughen area 38 is the preferred area of contact for the load ring 20. The technical functions of the load ring 20, for example urging seal ring 16 to seal and to prevent dirt to enter the seal, are enhanced when the load ring 20 engages the roughen area 38 because it is then in its proper final service position.

The adhesive 40 may be applied, as disclosed above, between at least one of the seal ring 16 and the annular inner peripheral surface 24, the seal ring 16 and the second surface 32, and the seal ring 16 and the second end face 28. Any one of these three positions or any combinations thereof may be used. According to at least one embodiment, the most preferred place for the adhesive 40 is between the seal ring 16 and the second end face 28, hereafter between the seal ring 16 and the second surface 32, and hereafter between the seal ring 16 and the annular inner peripheral surface 24. The adhesive 40 may be applied to one of the surfaces of the seal ring 16 and/or one of the surfaces of the load ring 20.

According to one embodiment, the roughen area 38 comprises a friction coefficient of at least 0.2. According to another embodiment, the roughen area 38 comprises a friction coefficient of at least 0.3. According to another embodiment, the roughen area 38 comprises a friction coefficient of at least 0.5. According to another embodiment, the roughen area 38 comprises an indent texture. The roughen area 38 may be provided by, for example, blasting, knurling, or controlled turning.

In at least one embodiment, the seal assembly is part of a track pin. A vehicle, such as for example a crawler tractor, may comprise the seal assembly.

### INDUSTRIAL APPLICABILITY

At least one embodiment of the disclosed seal assemblies and method for assembling the seal assemblies may be used for a track pin. Any vehicle may comprise such seal assemblies. Seal efficiency of such seal assemblies may be improved by improving the stability of a load ring within the seal assembly. The stability of the load ring may be increased by adhesive and/or friction. By providing adhesive and/or increased friction at certain areas between the load ring and a seal cavity and between the load ring and a seal ring, the stability of the load ring can be increased. This may result in an improved seal assembly.

In at least one embodiment, the combination of areas with increased friction and areas with adhesive is used to stabilize a load ring of a seal assembly.

At least one embodiment discloses a method for assembling such a seal assembly. When assembling the seal assembly, care should be taken that the parts of the seal assembly are assembled correctly. This may be provided for by allowing the adhesive to cure first when the parts of the seal assembly are in their final service positions. This may result in the stability of the load ring to increase. This may result in an improved seal assembly.

At least one embodiment provides a seal assembly that may keep dirt out and keep lubrication within a track joint. At least one embodiment maintains sealing capability. Embodiments of the seal assembly may maintain the different parts of a seal assembly in place to avoid displacement of any parts and resulting loss of sealing capability. The stability of a load ring within a seal assembly of at least one of the disclosed embodiments may be increased.

At least one embodiment may avoid grooving of the different parts of a seal assembly. Embodiments may keep costs for manufacturing and/or assembling a seal assembly within a track joint down. At least one embodiment may avoid cumbersome arrangements. At least one embodiment may provide a simple assembling process of a track joint seal assembly.

It will be apparent to those skilled in the art that various modifications and variations can be made to the seal assemblies and the method for assembling the seal assemblies. Other embodiments will be apparent to those skilled in the art from consideration of the specification and practice of the disclosed seal assemblies and method for assembling the seal assemblies. It is intended that the specification and examples be considered as exemplary only, with a true scope being indicated by the following claims and their equivalents.

What is claimed is:

1. A seal assembly for sealing between a first member and a second member of a joint, the first member being able to pivot about an axis of the joint relative to the second member, comprising:
a seal ring for a seal cavity of the first member,
a load ring for the seal cavity of the first member, the load ring comprising an annular outer peripheral surface for engaging the seal cavity, an annular inner peripheral surface for engaging the seal ring, a first end face for engaging the seal cavity, a second end face for at least partly engaging the seal ring, a first surface for engaging the seal cavity, the first surface connecting the first end face and the annular outer peripheral surface, and a second surface for engaging the seal ring, the second surface connecting the annular inner peripheral surface and the second end face, and
an adhesive between at least one of the seal cavity and the first end face, the seal cavity and the first surface, the seal ring and the annular inner peripheral surface, the seal ring and the second surface, and the seal ring and the second end face.

2. The seal assembly of claim 1, wherein the adhesive is an adhesive that cures after the joint has been assembled.

3. The seal assembly of claim 1, wherein the adhesive is annularly applied around the seal cavity.

4. The seal assembly of claim 1, wherein seal ring is comprised of plastic and comprises a seal lip.

5. A track pin comprising the seal assembly of claim 1.

6. A vehicle comprising the seal assembly of claim 1.

7. A method for assembling a seal assembly for sealing between a first member and a second member of a joint, the first member being able to pivot about an axis of the joint relative to the second member, the seal assembly comprising:
a seal ring for a seal cavity of the first member, and
a load ring for the seal cavity of the first member, the method comprising the following steps:
a) cleaning the seal ring and the load ring,
b) applying adhesive to at least one of the seal ring and the load ring,
c) assembling the load ring to the seal ring,
d) cleaning the seal cavity and the load ring,
e) applying adhesive to at least one of the seal cavity and the load ring,
f) assembling the load ring and the seal ring into the seal cavity into its final service position, and
g) allowing time for the adhesive to cure while the load ring and the seal ring are in the final service position.

8. The method of claim 7, wherein the load ring comprises an annular outer peripheral surface for engaging the seal cavity, an annular inner peripheral surface for engaging the seal ring, a first end face for engaging the seal cavity, a second end face for at least partly engaging the seal ring, a first surface for engaging the seal cavity, the first surface connecting the first end face and the annular outer peripheral surface, and a second surface for engaging the seal ring, the second surface connecting the annular inner peripheral surface and the second end face, and
wherein step b) the adhesive is applied between at least one of the seal ring and the annular inner peripheral surface, the seal ring and the second surface, and the seal ring and the second end face.

9. The method of claim 8, wherein step e) the adhesive is applied between at least one of the seal cavity and the first end face, and the seal cavity and the first surface.

10. The method of claim 7, wherein the cleaning is done by using chemicals.

11. The method of claim 7, wherein the adhesive in step b) is annularly applied to a corner of the seal cavity where the load ring would contact, and the adhesive in step e) is annularly applied to a corner of the seal ring being L-shaped.

12. The method of claim 7, wherein the steps d) and e) are omitted and the seal cavity comprises a roughen area where the load ring contacts the seal cavity.

13. The method of claim 12, wherein the roughening is made by one of the following group consisting of: blasting, knurling, and controlled turning.

14. A seal assembly for sealing between a first member and a second member of a joint, the first member being able to pivot about an axis of the joint relative to the second member, comprising:
a seal ring for a seal cavity of the first member,
a load ring for the seal cavity of the first member, the load ring having an annular outer peripheral surface for engaging the seal cavity, an annular inner peripheral surface for engaging the seal ring, a first end face for engaging the seal cavity, a second end face for at least partly engaging the seal ring, a first surface for engaging the seal cavity, the first surface connecting the first end face and the annular outer peripheral surface, and a second surface for engaging the seal ring,
the second surface connecting the annular inner peripheral surface and the second end face,
the seal cavity comprises a roughen area where the load ring contacts the seal cavity, and
an adhesive between at least one of the seal ring and the annular inner peripheral surface, the seal ring and the second surface, and the seal ring and the second end face.

15. The seal assembly of claim 14, wherein the roughen area comprises a friction coefficient of at least 0.2.

16. The seal assembly of claim 14, wherein the roughen area comprises an indent texture.

17. A track pin comprising the seal assembly of claim 14.

18. A vehicle comprising the seal assembly of claim 14.
